(19) United States
(12) Patent Application Publication
(10) Pub. No.: US 2016/0155346 A1
(43) Pub. Date: Jun. 2, 2016

(54) SYSTEM AND METHOD FOR LEARNING RECOMMENDATION SIMULATION

(71) Applicants: Jun WANG, San Jose, CA (US); Cole SHAW, Cambridge, MA (US); Kanji UCHINO, San Jose, CA (US); Richard LARSON, Lexington, MA (US); MASSACHUSETTS INSTITUTE OF TECHNOLOGY, Cambridge, MA (US)

(72) Inventors: Jun Wang, San Jose, CA (US); Cole Shaw, Belmont, MA (US); Kanji Uchino, San Jose, CA (US); Richard Larson, Lexington, MA (US)

(21) Appl. No.: 14/905,360

(22) PCT Filed: Jul. 16, 2013
(86) PCT No.: PCT/US2013/050685

§ 371 Date: Jan. 15, 2016

(51) Int. Cl. G09B 7/00; G06N 7/00; G09B 19/00; G06N 5/04

(52) U.S. Cl. CPC G09B 7/00; G06N 5/04; G06N 7/005; G09B 19/00

(57) ABSTRACT

A method and system for learning recommendation simulations for an online learning environment includes a topic graph generator, a virtual learner generator, and a learning recommendation simulator, A virtual learner traverses topics on the topic graph and learns from learning nuggets included in each topic. The virtual learner's learning performance is assessed and used to modify learning nugget attributes for each of the learning nuggets.

### BACKGROUND

1. Field of the Disclosure

This disclosure relates generally to online learning environments and, in particular, to a system and method for learning recommendation simulation.

2. Description of the Related Art

Online learning environments offer the potential to provide efficient and effective access to curriculum to large numbers of learners. In selecting a particular curriculum and individual topics within the curriculum, recommendation mechanisms may be useful by providing individualized guidance to learners and educators for identifying the best materials suited for a particular learner and/or a learning goal.

Conventional methods of evaluating recommendation systems have been based on collection and analysis of real-world data generated by actual students, for example, as in the case of real-world field experiments that measure actual learning outcomes. However, such real-world field experiments are limited by various factors, such as cost, time, and flexibility, and are not widely available for many different types of learners having a wide range of learning abilities and learning styles.

### SUMMARY

In one aspect, a disclosed method for evaluating learning recommendations includes generating a topic graph as an acyclic collection of topic nodes, each of the topic nodes representing individual topics for learning and including at least one learning nugget. Generating the topic graph may include generating, for each of the learning nuggets in the topic graph a quality rating, a learning style, a learning goal, and an effectiveness rating. The method may include generating a number of virtual learners, including generating, for each of the virtual learners cognitive model parameters, decision-making model parameters, learning ability parameters, a learning goal, and a preferred learning style. The method may further include recommending topic nodes from the topic graph to a virtual learner selected from the generated virtual learners, and enabling the virtual learner to select a first topic node in the topic graph. The method may also include recommending learning nuggets included in the first topic node to the first virtual learner, and enabling the virtual learner to select, based on the decision-making model parameters, a first learning nugget included in the first topic node. The method may further include enabling the virtual learner to interact, based on the cognitive model parameters, with the first learning nugget. After the virtual learner interacts with the first learning nugget, the method may include enabling an assessment of a mastery of the first learning nugget for the first virtual learner. Based on the mastery, the method may include updating the effectiveness rating for the first learning nugget.

Additional disclosed aspects for evaluating learning recommendations include an article of manufacture comprising a non-transitory, computer-readable medium, and computer executable instructions stored on the computer-readable medium. A further aspect includes a learning recommendation simulation system comprising a memory, a processor coupled to the memory, a network interface, and computer executable instructions stored on the memory.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram of selected elements of an embodiment of an online learning environment;

FIG. 2A is a block diagram of selected elements of an embodiment of a learning recommendation simulation system;

FIG. 2B is a block diagram of selected elements of an embodiment of a learning recommendation simulation system;

FIG. 3A is a flow chart depicting selected elements of an embodiment of a topic graph generator;

FIG. 3B is a block diagram of selected elements of an embodiment of a topic graph taxonomy;

FIG. 4A is a flow chart depicting selected elements of an embodiment of a virtual learner generator;

FIG. 4B is a block diagram of selected elements of an embodiment of a topic graph taxonomy;

FIG. 5 is a flow chart depicting selected elements of an embodiment of a learning recommendation simulator;

FIG. 6 is a flow chart depicting selected elements of an embodiment of a method for performing a learning nugget effectiveness rating process; and

FIG. 7 is a flow chart depicting selected elements of an embodiment of a method for performing a virtual learner process.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

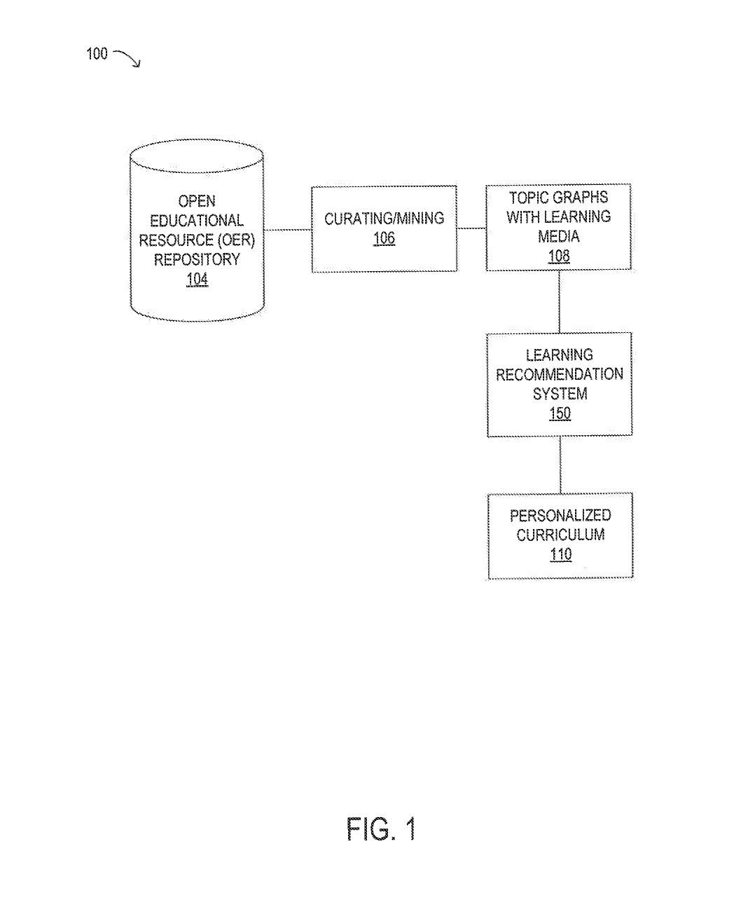

Particular embodiments and their advantages are best understood by reference to FIGS. 1 through 7, wherein like numbers are used to indicate like and corresponding parts.

Turning now to the drawings, FIG. 1 is a block diagram showing selected elements of an embodiment of online learning environment 100. Online learning environment 100 may represent a system accessible to a large number of users via a network, such as the Internet, for delivering educational materials and providing, for example, customized and/or personalized learning opportunities. One example of online learning environment 100 is called Guided Learning Pathways, a project initiated by Massachusetts Institute of Technology (MIT) and Fujitsu Laboratories of America, Inc.

In online learning environment 100, open educational resource (OER) repository 104 may represent a collection of educational materials, such as course curricula from a university or other higher educational organization, that is accessible in electronic form. By using curating/mining 106, OER repository 104 may be accessed to generate topic graphs with learning media 108. A topic graph included in topic graphs with learning media 108 may represent a data structure that organizes a catalog of core curricular concepts and basic learning topics for a subject or field of study. Topic graphs with learning media 108 may accordingly include pre-requisite relations among learning topics and may include mappings of such relations for various fields of study. Then, learning recommendation system 150 may provide personalized learning recommendations for users of online learning environment 100.

In FIG. 1, the learning recommendations provided by learning recommendation system 150 may include specific topics, learning materials, and or other media items that are stored in OER repository 104 and have been cataloged by topic graphs with learning media 108. Personalized curriculum 110 may represent a result of learning recommendation system 150, in various embodiments, that provides a personalized learning path for navigating a desired curriculum available from OER repository 104.

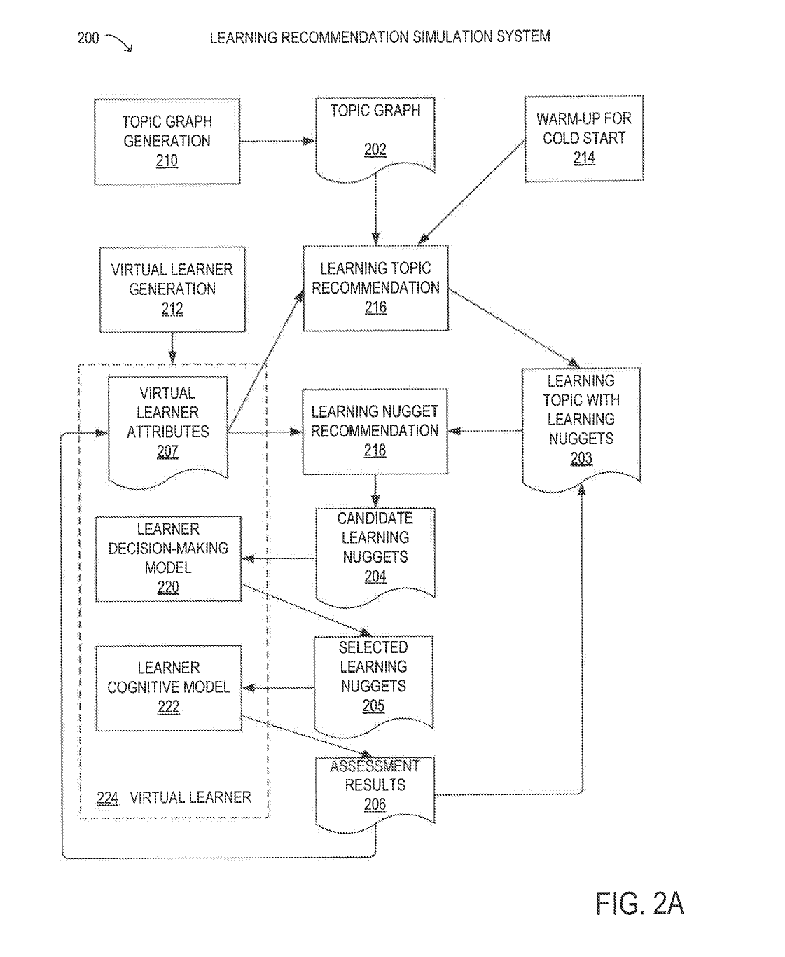

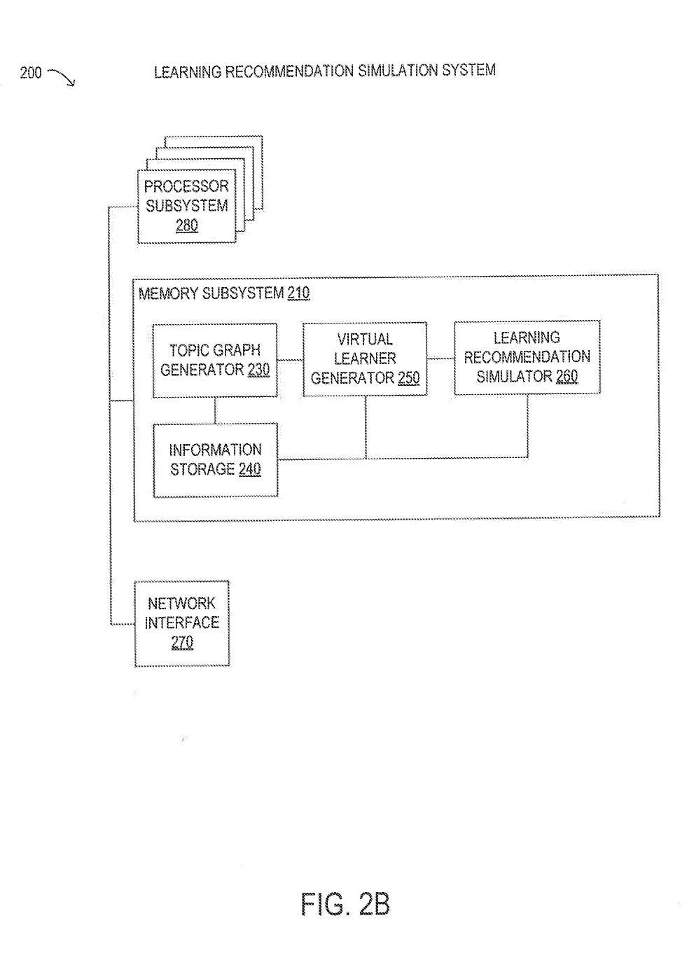

As will be described in further detail herein, a learning recommendation simulation system (see FIG. 2A) may enable online learning service providers and/or learning system designers to evaluate and select optimal learning recommendation algorithms, represented by learning recommendation system 150, which may be included with online learning environment 100. The learning recommendation simulation system, as disclosed herein, may perform a learning recommendation simulation to evaluate individual topics and learning media for effectiveness and suitability for a given learner and/or a given type of learner. In particular, the learning recommendation simulation system disclosed herein may generate a topic graph and a plurality of virtual learners during the learning recommendation simulation and simulate a learning interaction of the virtual learners across certain topics in the topic graph. The results of the learning recommendation simulation may enable an online learning system provider to find an optimal learning recommendation algorithm among different types of algorithms to implement in learning recommendation system. Because the learning recommendation simulation may be automated and executed by a processor having access to memory media storing processor executable instructions, the learning recommendation simulation system disclosed herein may support online resources in providing learning recommendations in various types of educational systems.

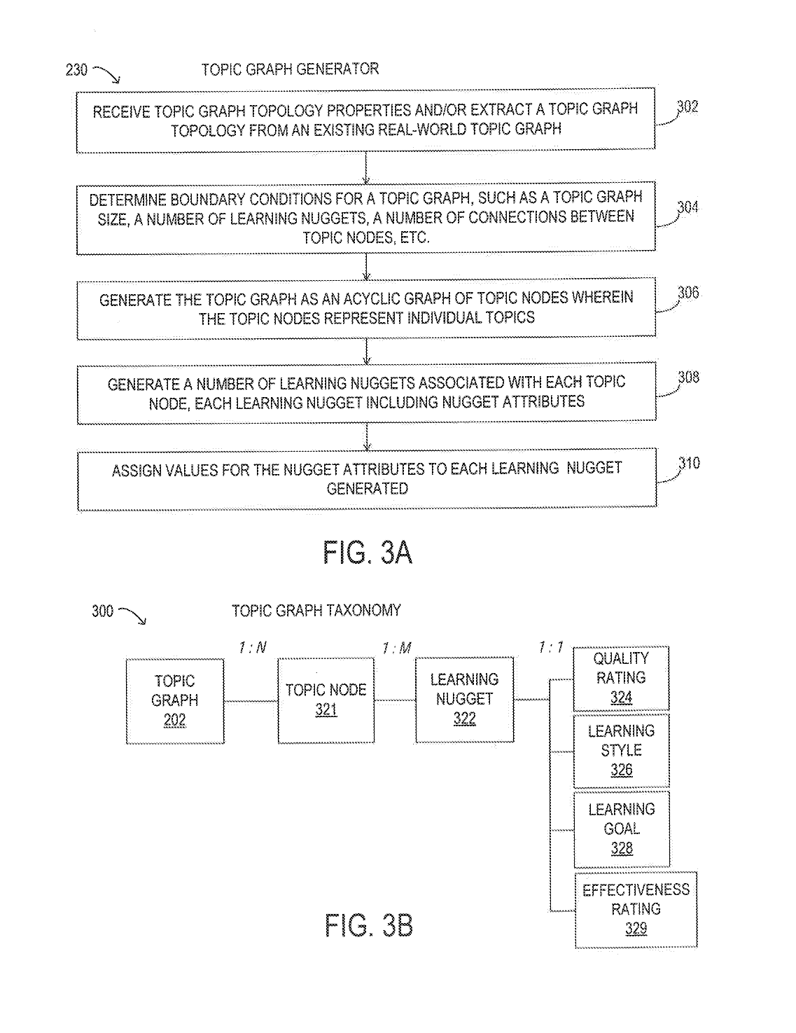

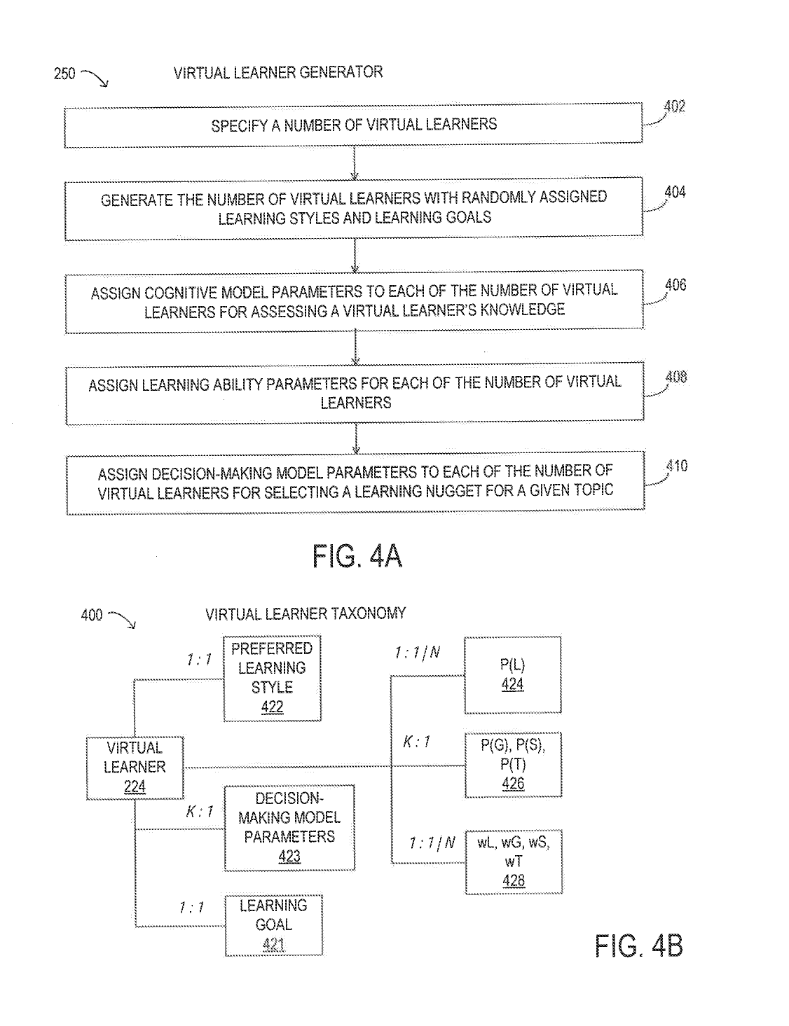

Turning now to FIG. 2A, a block diagram of selected elements of an embodiment of learning recommendation simulation system 200 is illustrated. The presentation of learning recommendation simulation system 200 is described as an overview in FIG. 2A and will be described in further detail in the remaining drawings. As shown, learning recommendation simulation system 200 may begin with topic graph generation 210 to result in topic graph 202, and virtual learner generation 212 to result in virtual learner 224. As shown, topic graph generation 210 may be performed by topic graph generator 230 (see FIGS. 2B, 3A-B), while virtual learner generation may be performed by virtual learner generator 250 (see FIGS. 2B, 4A-B). Virtual learner 224 is depicted as including virtual learner attributes 207 (see also FIG. 4B), learner decision-making model 220, and learner cognitive model 222.

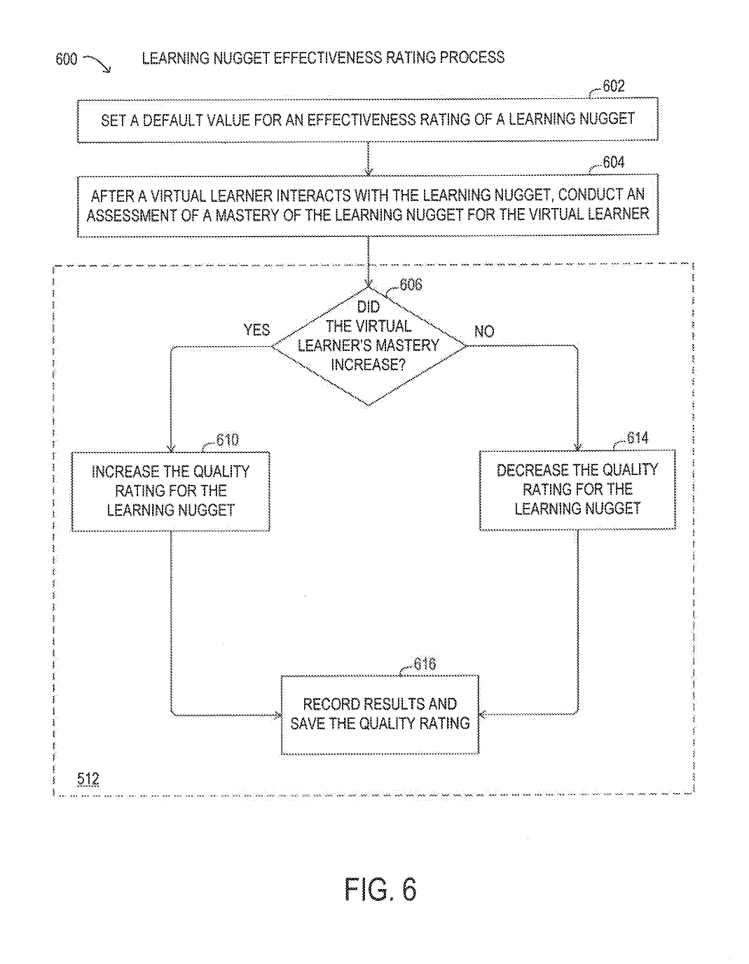

In FIG. 2A, after topic graph 202 is generated, learning topic recommendation 216 may receive, as an input, virtual learner attributes 207 and provide, as an output, learning topic with learning nuggets 203 to learning nugget recommendation 218. Then, learning nugget recommendation 218 may receive, as an input, virtual learner attributes 207 and may perform a desired recommendation algorithm to generate candidate learning nuggets 204 to present to virtual learner 224, which may use learner decision-making model 220 to result in selected learning nuggets 205. One embodiment of a recommendation algorithm used by learning nugget recommendation is described in method 600 (see FIG. 6). Then, virtual learner 224 may interact with selected learning nuggets 205 using learner cognitive model 222 to generate assessment results 206, which may be used to update virtual learner attributes 207 and learning topic with learning nuggets 203.

Also shown in FIG. 2A is warm-up for cold start 214, which provides certain data to learning topic recommendation 216 for initializing learning recommendation simulation system 200 to improve cold start performance. A cold start of learning recommendation simulation system 200 may occur when no previous behavioral data, such as virtual learner attributes 207, are available upon start up. As shown, warm-up for cold start 214 may provide emerging behavioral data for virtual learners over a specific period of time as a synthetic data set to initialize learning recommendation simulation system 200.

Referring now to FIG. 2B, a block diagram of selected elements of an embodiment of learning recommendation simulation system 200 is illustrated. In FIG. 2B, learning recommendation simulation system 200 is represented as physical and logical components for implementing the functionality depicted in FIG. 2A, and may accordingly include processor subsystem 280, memory subsystem 210, and network interface 270. Processor subsystem 280 may represent one or more individual processing units and may execute program instructions, interpret data, and/or process data stored by memory subsystem 210 and/or another component of learning recommendation simulation system 200.

In FIG. 2B, memory subsystem 210 may be communicatively coupled to processor subsystem 280 and may comprise a system, device, or apparatus suitable to retain program instructions and/or data for a period of time (e.g., computer-readable media). Memory subsystem 210 may include various types components and devices, such as random access memory (RAM), electrically erasable programmable read-only memory (EEPROM), a PCMCIA card, flash memory, solid state disks, hard disk drives, magnetic tape libraries, optical disk drives, magneto-optical disk drives, compact disk drives, compact disk arrays, disk array controllers, and/or any suitable selection or array of volatile or non-volatile memory. Non-volatile memory refers to a memory that retains data after power is turned off. It is noted that memory subsystem 210 may include different numbers of physical storage devices, in various embodiments.

As shown in FIG. 2B, memory subsystem 210 may include topic graph generator 230, information storage 240, virtual learner generator 250, and learning recommendation simulator 260. In some embodiments, topic graph generator 230, virtual learner generator 250, and learning recommendation simulator 260 may represent respective sets of computer-readable instructions that, when executed by a processor, such as processor subsystem 280, result in generation of learning recommendations for specific topics, as will be described in further detail. Information storage 240 may store various data and parameters associated with learning simulations performed using learning recommendation simulation system 200.

In operation, learning recommendation simulation system 200 may provide learning recommendation simulations that are an alternative to real-world recommender systems based on real-world field experiments, which may be costly and time consuming. A learning recommendation simulation may provide many advantages, such as a rigorous experimental design and fine-grained control over may possible kinds of potential learners with a wide range of learning abilities and learning styles. The learning recommendation simulation may further be independent of ethical and practical constraints that field experiments using human individuals are subject to.

Turning now to FIG. 3A, selected elements of an embodiment of topic graph generator 230 (see also FIG. 2B) representing operations for generating topic graphs are shown in flow chart format. It is noted that certain operations depicted in topic graph generator 230 may be rearranged or omitted, as desired.

A topic graph (not shown) may describe a directed acyclic data structure with individual topic nodes and connections between the topic nodes. The topic nodes may represent individual basic concepts or objectives within a subject or knowledge domain. For example, a typical course syllabus in a traditional education system may comprise a set of topics represented by topic nodes in the topic graph. The topic graph may include various sets of topics for different courses and, with sufficient complexity, may include complete educational programs comprising different series of courses. The connections between the topic nodes may represent prerequisite relationships between individual topic nodes. It is noted that a given topic graph may accordingly include one or more individual curriculum graphs that are independent of each other. An example of an educational program represented by a topic graph is a high school or university diploma. A learning goal given by a certain pathway in a topic graph may represent, for example, a particular diploma or degree program offered as course curricula (e.g., a subject major of a degree).

Each topic node in a topic graph may include one or more learning nuggets, as used herein, which may refer to learning materials that pertain to a specific topic node. Learning nuggets may contain different types of media items, such as visual (images, slideshows, videos, shows, movies, etc.), auditory (podcasts, radio programs, narratives, audio literary works, etc.), textual (notes, texts, publications, etc.), and kinesthetic (exercises, motions, sports, etc.), among others. Certain parameters, or meta-data, may be associated with individual learning nuggets, such as quality ratings, learning styles, learning goals, and effectiveness ratings, as will be described in further detail. The effectiveness ratings may represent feedback information about outcomes of learners that use the learning nugget over time.

In FIG. 3A, topic graph generator 240 may begin by receiving (operation 302) topic graph topology properties and/or extracting (operation 302) a topic graph topology from an existing real-world topic graph. Then, boundary conditions for a topic graph, such as a topic graph size, a number of learning nuggets, a number of connections between topic nodes, etc. may be determined (operation 304). In some embodiments, the boundary conditions are provided as input from a user. The topic graph may be generated (operation 306) as an acyclic graph of topic nodes in which the topic nodes represent individual topics. A number of learning nuggets associated with each topic node may be generated (operation 308), where each learning nugget includes nugget attributes. It is noted that different topic nodes may have different numbers of learning nuggets. The nugget attributes may include a quality rating, a learning style, a learning goal, and an effectiveness rating. Finally, values for the nugget attributes may be assigned (operation 310) to each nugget generated. It is noted that values for learning style and learning goal attributes of learning nuggets may be assigned according to a specific random model in learning recommendation simulation system 200.

Referring now to FIG. 3B, a block diagram of selected elements of an embodiment of topic graph taxonomy 300 is illustrated. In FIG. 3B, topic graph taxonomy 300 may define structures and relationships of elements included in a topic graph. Topic graph 202 may represent a direct acyclic graph of individual topics, as described above. Topic graph 202 may include N number of topic nodes 321, shown by a 1:N relationship in FIG. 3B. Topic node 321 may, in turn, include M number of learning nuggets 322, shown by a 1:M relationship in FIG. 3B. It is noted that M may be different for different instances of topic node 321. In addition to the actual media item (not shown) included in learning nugget 322, each instance of learning nugget 322 may be associated with nugget attributes, shown by a 1:1 relationship in FIG. 3B. As shown, nugget attributes may include quality rating 324, learning style 326, learning goal 328, and effectiveness rating 329. Quality rating 324 may be a constant measure of a learning quality of learning nugget 322. Effectiveness rating 329 may be a measure of a learning value of learning nugget 322, and may be updated by learning recommendation simulator 260 after each learning event (i.e., after an assessment). In this manner, learning recommendation simulation system 200 may provide effectiveness ratings 329 for a plurality of learning nuggets 322 included in topic graph 202. Learning style 326 may be a descriptor of a type of learning style that learning nugget 322 is best suited for. For example, when learning nugget 322 includes video content, learning style 326 may indicate a visual and/or passive learning style, etc. Learning goal 328 may be a goal of a learner intending to use the curriculum described by topic graph 202. Learning goal 328 may be a learning path, such as a degree program in a certain major, or a path to a particular topic node 321 in topic graph 202. It is noted that learners may begin learning on topic graph 202 based on some amount of initial knowledge, and may accordingly begin a given learning goal 328 from different starting points, according to the learner's individual educational experience and/or knowledge level. As an attribute of learning nugget 322, learning goal 328 may represent a learning goal provided by topic graph 202 that the learning materials included in learning nugget 322 can help attain.

Turning now to FIG. 4A, selected elements of an embodiment of virtual learner generator 250 (see also FIG. 2B) representing operations for generating virtual learners are shown in flow chart format. It is noted that certain operations depicted in virtual learner generator 250 may be rearranged or omitted, as desired.

A virtual learner, as used herein, may refer to a simulated learning module representing attributes and behaviors of real-life individuals. A virtual learner has a specific learning goal in mind, has a preferred learning style, and some amount of previous knowledge. A virtual learner in learning recommendation simulation system 200 may study learning nuggets 322 and may traverse topic graph 202 over time. In learning recommendation simulation system 200, a virtual learner may learn using a cognitive model to simulate a human learning process, and may employ a decision-making model to simulate selection from learning nugget recommendations.

The cognitive model that a virtual learner uses may aid in providing an accurate assessment of the knowledge that the virtual learner acquires. In learning recommendation simulation system 200, a Bayesian Knowledge Tracing (BKT) model is employed in a novel manner to simulate virtual learners. The BKT model involves assigning unique cognitive attributes used to predict a probability that a specific virtual learner can correctly complete an assessment on a current topic, such as provided by a learning nugget. The virtual learner cognitive model is updated with new values, where appropriate, after each assessment to reflect mastery of the current topic. Mastery of a current topic is determined using the BKT model and is defined as exceeding a specific threshold probability of mastery of the current topic. In certain embodiments, the BKT model is represented as a dynamic Bayesian network. The parameters in the BKT model are given in Table 1.

TABLE 1
Parameters in the BKT model.

| PARAMETER | DEFINITION/DESCRIPTION |
|---|---|
| P(L) | Prior probability that a virtual learner had learned a |
| | topic before assessment. As mastery of topics is attained, |
| | P(L) is updated accordingly. |
| P(Lₙ₋₁) \| Cₙ | Posterior probability that a virtual learner had learned |
| P(Lₙ₋₁) \| Eₙ | a topic after assessment (C—correctly, E—erroneously). |
| P(G) | Probability that a virtual learner who does not know a |
| | topic will guess and give a correct answer. 1 − P(G) is |
| | the probability that the virtual learner will guess and |
| | give an incorrect answer. |
| P(S) | Probability that a virtual learner who knows a topic will |
| | give an erroneous answer, 1 − P(S) is the probability that |
| | the virtual learner will and give a correct answer. |
| P(T) | Probability that a virtual learner, regardless of correctness |
| | in answering the assessment, will still make the transition |
| | from the unlearned to the learned. |

In addition to the parameters described in Table 1, each virtual learner may be associated with 4 weighting values, wL, wG, wS, and wT, that represent learning ability parameters that are recalculated for each topic node. The weighting values are intended to provide individualized ability and/or behavior of virtual learners in understanding a topic. In particular embodiments, the weighting factors may be initialized with values in the range of ±20%. The weighting factors may be applied according to Equations 1 and 2 for parameter pX with weight wX to determine weighted value W and new weight-adjusted parameter pX_{new}.

$$\begin{matrix}W = \frac{pX + wX}{1 - pX} & Equation ( 1 ) \\ {pX}_{new} = \frac{w}{1 + w} & Equation ( 2 )\end{matrix}$$

Thus, an outcome of each topic node in the topic graph is calculated with individual probabilities for each virtual learner. A mastery level may then be calculated using pX_{new} for each parameter.

In learning recommendation simulation system 200, virtual learners may select learning nuggets from a list of recommendations using a decision-making model. The decision-making model is chosen to reflect the property that virtual learners may not follow recommendations provided to them. In given embodiments, a simple random model is used as a decision-making model. For example, a constant global probability (e.g., 80%) may be used to describe a virtual learner's decision to follow a particular recommendation of a learning nugget.

In FIG. 4A, virtual learner generator 250 may begin by specifying (operation 402) a number of virtual learners. The number of virtual learners may be generated (operation 404) with randomly assigned learning styles and learning goals. Cognitive model parameters may be assigned (operation 406) to each of the number of virtual learners for assessing a virtual learner's knowledge. Learning ability parameters may be assigned (operation 408) for each of the number of virtual learners. Finally, decision-making parameters may be assigned (operation 410) to each of the number of virtual learners for selecting a learning nugget for a given topic.

Referring now to FIG. 4B, a block diagram of selected elements of an embodiment of virtual learner taxonomy 400 is illustrated. In FIG. 4B, virtual learner taxonomy 400 may define structures and relationships of elements for K-number of virtual learners 224. Virtual learner 224 may include preferred learning style 422 and learning goal 421, shown by a 1:1 relationship to virtual learner 224 in FIG. 4B. Decision-making model parameters 423 may be global for all virtual learners, shown by a K:1 relationship in FIG. 4B. Also shown included with virtual learner 224 is cognitive model parameter P(L) 424, which is shown by a 1:1 relationship for each of N topic nodes 321. The other cognitive model parameters P(G), P(S), P(T) 426 are shown being globally constant for all virtual learners 224, which is shown by a K:1 relationship in FIG. 4B. The learning ability parameters wL, wG, wS, wT 428 are shown with a 1:1 relationship for each of N topic nodes 321 with each virtual learner 224, and may be recalculated after each topic node and/or learning nugget is traversed.

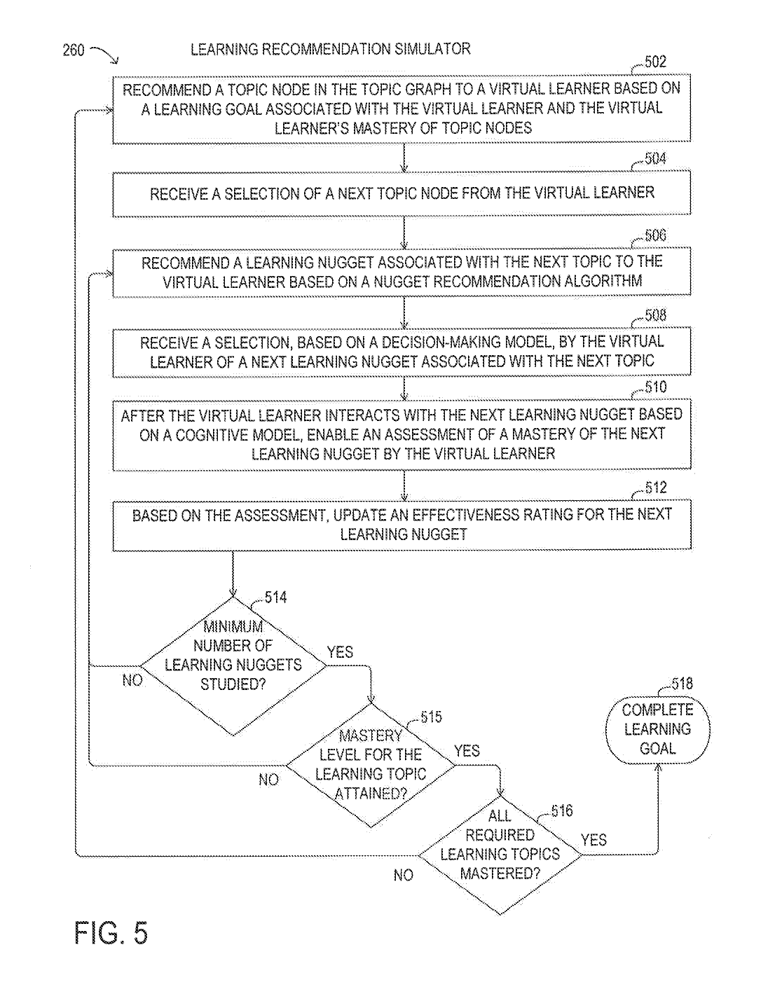

Turning now to FIG. 5, selected elements of an embodiment of learning recommendation simulator 260 (see also FIG. 2B), representing operations for performing topic recommendation, selection and evaluation, are shown in flow chart format. It is noted that certain operations depicted in learning recommendation simulator 260 may be rearranged or omitted, as desired.

In FIG. 5, learning recommendation simulator 260 shows operations that may be performed after topic graph generator 230 and virtual learner generator 250 have been executed. Learning recommendation simulator 260 may begin by recommending (operation 502) a topic node in the topic graph to a virtual learner, based on a learning goal associated with the virtual learner and the virtual learner's mastery of topic nodes. Operation 502 may include selecting, for recommending, topic nodes based on the learning goal for the virtual learner. Operation 502 may also include excluding, from recommending, topic nodes for which the virtual learner has attained mastery above a minimum level of mastery. A selection of a next topic node may be received (operation 504) from the virtual learner. It is noted that the virtual learner is not compelled to select the topic node recommended in operation 502. A learning nugget associated with the next topic may be recommended (operation 506) to the virtual learner based on a nugget recommendation algorithm. The nugget recommendation algorithm may include an algorithm based on a match between the learning goal of a learning nugget and the learning goal of the virtual learner. The nugget recommendation algorithm may include an algorithm based on a match between the learning style of a learning nugget and the preferred learning style of the virtual learner. The nugget recommendation algorithm may include an algorithm based on the effectiveness rating of a learning nugget. Combinations of such algorithms may also be used in certain embodiments. A selection by the virtual learner, based on a decision-making model, of a next learning nugget associated with the next topic may be received (operation 508). After the virtual learner interacts with the next learning nugget based on a cognitive model, an assessment of a mastery of the next learning nugget by the virtual learner may be enabled (operation 510). Based on the assessment, an effectiveness rating for the next learning nugget may be updated (operation 512). Then a decision may be made whether a minimum number of learning nuggets have been studied (operation 514). When the result of operation 514 is NO, learning recommendation simulator 260 may return to operation 506. When the result of operation 514 is YES, learning recommendation simulator 260 may make a further decision, whether a mastery level for the learning topic was attained (operation 515). When the result of operation 515 is NO, learning recommendation simulator 260 may return to operation 506. When the result of operation 515 is YES, learning recommendation simulator 260 may make a further decision, whether all required learning topics have been mastered (operation 516). When the result of operation 516 is NO, learning recommendation simulator 260 may return to operation 502. When the result of operation 516 is YES, learning recommendation simulator 260 may complete (operation 518) the learning goal.

Turning now to FIG. 6, selected elements of an embodiment of method 600 for performing a learning nugget effectiveness rating process are shown in flow chart format. It is noted that certain operations depicted in method 600 may be rearranged or omitted, as desired.

Method 600 may begin by setting (operation 602) a default value for an effectiveness rating of a learning nugget. After a virtual learner interacts with the learning nugget, an assessment of a mastery of the learning nugget for the virtual learner may be conducted (operation 604). Then, a decision may be made whether the virtual learner's mastery increased (operation 606). When the result of operation 606 is YES, the effectiveness rating for the learning nugget may be increased (operation 610), after which method 600 may proceed to operation 616. When the result of operation 606 is NO, the effectiveness rating for the learning nugget may be decreased (operation 614), after which method 600 may proceed to operation 616. It is noted that portions of method 600 (i.e., operations 606-616) may represent an embodiment of operation 512 (see FIG. 5). After operations 610 and 614, results may be recorded (operation 616) and the effectiveness rating may be saved (operation 616). It is noted that the results of method 600 as well as values described in method 600 may be stored using information storage 240 (see FIG. 2B).

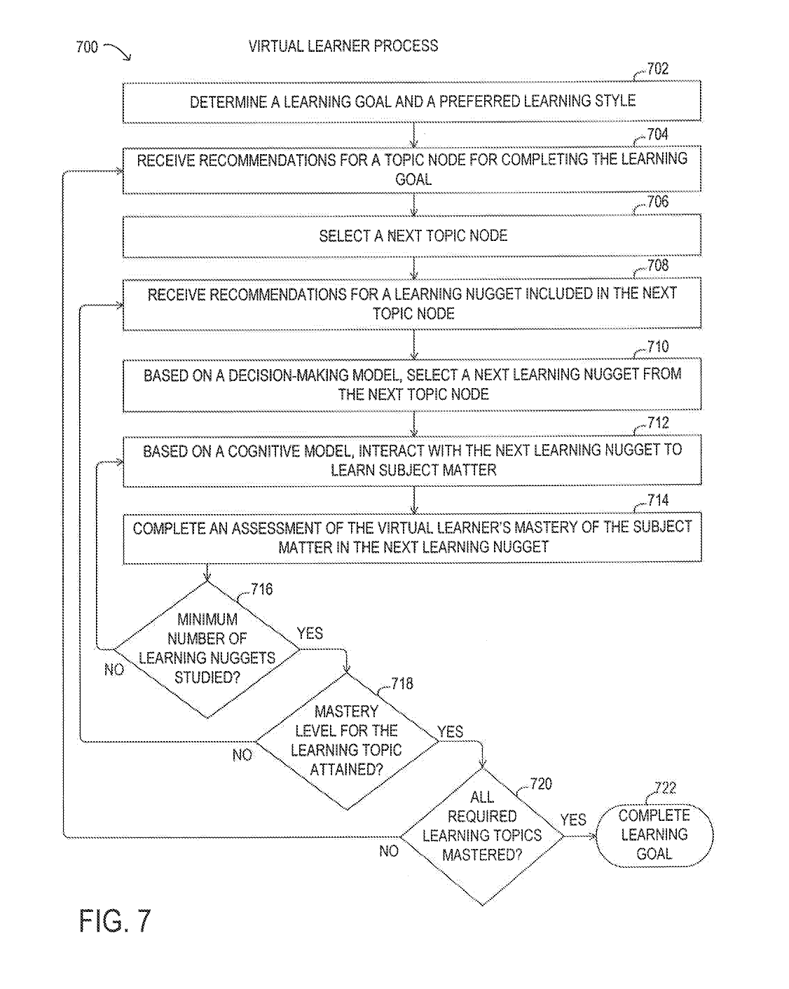

Turning now to FIG. 7, selected elements of an embodiment of method 700 for performing a virtual learner process are shown in flow chart format. Method 700 may represent operations performed by virtual learner 224 (see FIG. 4B). It is noted that certain operations depicted in method 700 may be rearranged or omitted, as desired.

Method 700 may begin by determining (operation 702) a learning goal and a preferred learning style. Recommendations for a topic node for completing the learning goal may be received (operation 704). A next topic node may be selected (operation 706).

Recommendations for a learning nugget included in the next topic node may be received (operation 708). Based on a decision-making model, a next learning nugget may be selected (operation 710) from the next topic node. Based on a cognitive model, method 700 may interact (operation 712) with the next learning nugget to learn subject matter. An assessment of the virtual learner's mastery of the subject matter in the next learning nugget may be completed (operation 714). Then, a decision may be made whether a minimum number of learning nuggets have been studied (operation 716). When the result of operation 716 is NO, method 700 may return to operation 712. When the result of operation 716 is YES, method 700 may make a further decision, whether a mastery level for the learning topic was attained (operation 718). When the result of operation 718 is NO, method 700 may return to operation 708. When the result of operation 718 is YES, method 700 may make a further decision, whether all required learning topics have been mastered (operation 720). When the result of operation 720 is NO, method 700 may return to operation 704. When the result of operation 720 is YES, method 700 may complete (operation 722) the learning goal.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method for evaluating learning recommendations, comprising:
generating a topic graph as an acyclic collection of topic nodes, each of the topic nodes representing individual topics for learning and including at least one learning nugget, including generating, for each of the learning nuggets in the topic graph, learning nugget attributes;
generating a number of virtual learners, including generating, for each of the virtual learners, virtual learner attributes;
recommending topic nodes from the topic graph to a first virtual learner selected from the generated virtual learners;
enabling the virtual learner to select a first topic node in the topic graph;
recommending learning nuggets included in the first topic node to the first virtual learner;
enabling the first virtual learner to select a first learning nugget included in the first topic node;
enabling the first virtual learner to interact with the first learning nugget;
after the first virtual learner interacts with the first learning nugget, enabling an assessment of a mastery of the first learning nugget for the first virtual learner; and
based on the mastery, updating the learning nugget attributes for the first learning nugget.

2. The method of claim 1, further comprising:
recording results of the assessment,
wherein recommending topic nodes from the topic graph to the first virtual learner further comprises:
selecting, for recommending, topic nodes based on the learning goal for the first virtual learner, and
excluding, from recommending, topic nodes for which the first virtual learner has attained mastery above a minimum level of mastery.

3. The method of claim 1, wherein the learning nugget attributes include:
a quality rating;
a learning style;
a learning goal; and
an effectiveness rating.

4. The method of claim 3, wherein recommending learning nuggets included in the first topic node to the first virtual learner further comprises:
recommending the learning nuggets based on a nugget recommendation algorithm selected from an algorithm based on at least one of:
a match between the learning goal of a learning nugget and the learning goal of the first virtual learner;
a match between the learning style of a learning nugget and the preferred learning style of the first virtual learner; and
the effectiveness rating of a learning nugget.

5. The method of claim 3, wherein updating the learning nugget attributes for the first learning nugget further comprises:
when the mastery of the first learning nugget for the first virtual learner increases, increasing the effectiveness rating; and
when the mastery of the first learning nugget for the first virtual learner decreases, decreasing the effectiveness rating.

6. The method of claim 1, wherein the virtual learner attributes include:
cognitive model parameters;
decision-making model parameters;
learning ability parameters;
a learning goal; and
a preferred learning style.

7. The method of claim 6, wherein enabling the first virtual learner to select the first learning nugget is based on the decision-making model parameters, and wherein the decision-making parameters comprise:
a first probability that a virtual learner will follow a learning nugget recommendation.

8. The method of claim 6, wherein enabling the first virtual learner to interact with the first learning nugget is based on the cognitive model parameters, wherein the cognitive model parameters comprise:
a second probability that a virtual learner had previously learned an individual topic;
a third probability that a virtual learner will correctly guess an answer during the assessment;
a fourth probability that a virtual learner will inadvertently make an error answering during the assessment; and
a fifth probability that a virtual learner will learn an individual topic irrespective of the mastery of a learning nugget.

9. The method of claim 8, wherein the learning ability parameters comprise:
a first weighting factor of the second probability;
a second weighting factor of the third probability;
a third weighting factor of the fourth probability; and
a fourth weighting factor of the fifth probability.

10. An article of manufacture comprising:
a non-transitory, computer-readable medium; and
computer executable instructions stored on the computer-readable medium, the instructions readable by a processor and, when executed, for causing the processor to:
generate a topic graph as an acyclic collection of topic nodes, each of the topic nodes representing individual topics for learning and including at least one learning nugget, including generation, for each of the learning nuggets in the topic graph, of learning nugget attributes;
generate a number of virtual learners, including generation, for each of the virtual learners, of virtual learner attributes;
recommend topic nodes from the topic graph to a first virtual learner selected from the generated virtual learners;
enable the first virtual learner to select a first topic node in the topic graph;
recommend learning nuggets included in the first topic node to the first virtual learner;
enable the first virtual learner to select a first learning nugget included in the first topic node;
enable the first virtual learner to interact with the first learning nugget;
after the first virtual learner interacts with the first learning nugget, enable an assessment of a mastery of the first learning nugget for the first virtual learner; and
based on the mastery, update the learning nugget attributes for the first learning nugget.

11. The article of manufacture of claim 10, further comprising instructions for causing the processor to:
record results of the assessment,
wherein the instructions to recommend topic nodes from the topic graph to the first virtual learner further comprise instructions to:
select, for recommendation, topic nodes based on the learning goal for the first virtual learner; and
exclude, from recommendation, topic nodes for which the first virtual learner has attained mastery above a minimum level of mastery.

12. The article of manufacture of claim 10, wherein the learning nugget attributes include:
a quality rating;
a learning style;
a learning goal; and
an effectiveness rating.

13. The article of manufacture of claim 12, wherein the instructions to recommend learning nuggets included in the first topic node to the first virtual learner further comprise instructions to:
recommend the learning nuggets based on a nugget recommendation algorithm selected from an algorithm based on at least one of:
a match between the learning goal of a learning nugget and the learning goal of the first virtual learner;
a match between the learning style of a learning nugget and the preferred learning style of the first virtual learner; and
the effectiveness rating of a learning nugget.

14. The article of manufacture of claim 12, wherein the instructions to update the effectiveness rating for the first learning nugget further comprise instructions to:
when the mastery of the first learning nugget for the first virtual learner increases, increase the effectiveness rating; and
when the mastery of the first learning nugget for the first virtual learner decreases decrease the effectiveness rating.

15. The article of manufacture of claim 10, wherein the virtual learner attributes include:
cognitive model parameters;
decision-making model parameters;
learning ability parameters;
a learning goal; and
a preferred learning style.

16. The article of manufacture of claim 15, wherein the instructions to enable the first virtual learner to select the first learning nugget are based on the decision-making model parameters, and wherein the decision-making model parameters comprise:
a first probability that a virtual learner will follow a learning nugget recommendation.

17. The article of manufacture of claim 15, wherein the instructions to enable the first virtual learner to interact with the first learning nugget are based on the cognitive model parameters, and wherein the cognitive model parameters comprise:
a second probability that a virtual learner had previously learned an individual topic;
a third probability that a virtual learner will correctly guess an answer during the assessment;
a fourth probability that a virtual learner will inadvertently make an error answering during the assessment; and
a fifth probability that a virtual learner will learn an individual topic irrespective of the mastery of a learning nugget.

18. The article of manufacture of claim 17, wherein the learning ability parameters comprise:
a first weighting factor of the second probability;
a second weighting factor of the third probability;
a third weighting factor of the fourth probability; and
a fourth weighting factor of the fifth probability.

19. A learning recommendation simulation system, comprising:
a memory;
a processor coupled to the memory;
a network interface; and
computer executable instructions stored on the memory, the instructions readable by the processor and, when executed, for causing the processor to:
generate a topic graph as an acyclic collection of topic nodes, each of the topic nodes representing individual topics for learning and including at least one learning nugget, including generation, for each of the learning nuggets in the topic graph, of learning nugget attributes;
generate a number of virtual learners, including generation, for each of the virtual learners, of virtual learner attributes;
recommend topic nodes from the topic graph to a first virtual learner selected from the generated virtual learners;
enable the first virtual learner to select a first topic node in the topic graph;
recommend learning nuggets included in the first topic node to the first virtual learner;
enable the first virtual learner to select a first learning nugget included in the first topic node;
enable the first virtual learner to interact with the first learning nugget;
after the first virtual learner interacts with the first learning nugget, enable an assessment of a mastery of the first learning nugget for the first virtual learner; and
based on the mastery, update the learning nugget attributes for the first learning nugget.

20. The learning recommendation simulation system of claim 19, further comprising instructions for causing the processor to:
record results of the assessment,
wherein the instructions to recommend topic nodes from the topic graph to the first virtual learner further comprise instructions to:
select, for recommendation, topic nodes based on the learning goal for the first virtual learner; and
exclude, from recommendation, topic nodes for which the first virtual learner has attained mastery above a minimum level of mastery.

21. The learning recommendation simulation system of claim 19, wherein the learning nugget attributes include:
a quality rating;
a learning style;
a learning goal; and
an effectiveness rating.

22. The learning recommendation simulation system of claim 21, wherein the instructions to recommend learning nuggets included in the first topic node to the first virtual learner further comprise instructions to:
recommend the learning nuggets based on a nugget recommendation algorithm selected from an algorithm based on at least one of:
a match between the learning goal of a learning nugget and the learning goal of the first virtual learner;
a match between the learning style of a learning nugget and the preferred learning style of the first virtual learner; and
the effectiveness rating of a learning nugget.

23. The learning recommendation simulation system of claim 21, wherein the instructions to update the effectiveness rating for the first learning nugget further comprise instructions to:
when the mastery of the first learning nugget for the first virtual learner increases, increase the effectiveness rating; and
when the mastery of the first learning nugget for the first virtual learner decreases, decrease the effectiveness rating.

24. The learning recommendation simulation system of claim 19, wherein the virtual learner attributes include:
cognitive model parameters;
decision-making model parameters;
learning ability parameters;
a learning goal; and
a preferred learning style.

25. The learning recommendation simulation system of claim 24, wherein the instructions to enable the first virtual learner to select the first learning nugget are based on the decision-making model parameters, and wherein the decision-making model parameters comprise:
a first probability that a virtual learner will follow a learning nugget recommendation.

26. The learning recommendation simulation system of claim 24, wherein the instructions to enable the first virtual learner to interact with the first learning nugget are based on the cognitive model parameters, and wherein the cognitive model parameters comprise:
a second probability that a virtual learner had previously learned an individual topic;
a third probability that a virtual learner will correctly guess an answer during the assessment;
a fourth probability that a virtual learner will inadvertently make an error answering during the assessment; and
a fifth probability that a virtual learner will learn an individual topic irrespective of the mastery of a learning nugget.

27. The learning recommendation simulation system of claim 26, wherein the learning ability parameters comprise:
a first weighting factor of the second probability;
a second weighting factor of the third probability;
a third weighting factor of the fourth probability; and
a fourth weighting factor of the fifth probability.
